(19) United States
(12) Patent Application Publication
(10) Pub. No.: US 2025/0381971 A1
(43) Pub. Date: Dec. 18, 2025

(54) ELECTRONIC SIDE VIEW MIRROR WARNING SYSTEM

(71) Applicant: CHIMEI MOTOR ELECTRONICS CO., LTD., TAINAN CITY (TW)

(72) Inventors: Hsueh-Hsien HSU, TAINAN CITY (TW); Cheng-Chian WANG, TAINAN CITY (TW); Chih-Ping CHANG, TAINAN CITY (TW)

(21) Appl. No.: 18/746,072

(22) Filed: Jun. 18, 2024

(51) Int. Cl. B60W 50/14; B60K 35/28; B60R 1/06; B60R 1/12; G06V 20/56

(52) U.S. Cl. CPC B60W 50/14; B60K 35/28; B60R 1/06; B60R 1/12; G06V 20/56; B60K 2360/1438; B60K 2360/176; B60K 2360/178; B60R 2001/1253; B60R 2300/105; B60R 2300/8026; B60R 2300/8093; B60W 2050/143; B60W 2050/146; B60W 2420/403

(57) ABSTRACT

An electronic side view mirror warning system includes two cameras, a processor, and a display device. The cameras are mounted on both sides of a front of a vehicle to capture side images of front wheels. The processor is disposed in a cab and stores textures and first image features of road conditions, and second image features of objects. The processor can receive the side images and perform image recognition processing on the side images using the textures, the first image features, and the second image features to obtain a driving road condition information of the vehicle. The display device is disposed in the cab, and can receive and display side images and issue a warning signal. When the driving road condition information indicates that there is a risk within an expected driving range of the vehicle, the processor controls the display device to issue the warning signal.

### BACKGROUND

### Field of Invention

The present disclosure relates to a driving monitoring technology, and more particularly, to an electronic side view mirror warning system.

### Description of Related Art

Currently, most vehicles are equipped with blind spot detection (blind spot detection, BSD) devices. The blind spot detection devices are usually mounted on side view mirrors of the vehicle to detect images behind the side view mirrors to provide the driver with information on whether there are objects on the sides of the vehicle. However, such a blind spot detection device can only detect objects at the rear and cannot detect moving objects in front of the side view mirror mounted outside the vehicle. As a result, the driver cannot know the situation of the blind spot in front of the vehicle, which causes driving risks.

Therefore, there is a need for a driving monitoring and warning system to solve the problems of the aforementioned conventional technologies.

### SUMMARY

Therefore, one objective of the present disclosure is to provide an electronic side view mirror warning system, a processor of which can receive side images of front wheels on both sides of a vehicle captured by cameras, and can use a texture and image feature database built in the processor to perform image recognition processing on the side images, such that driving road condition information such as whether an expected driving range of the vehicle is a drivable road and whether there are obstacles. According to the driving road condition information, the processor can control a display device to issue a warning screen and/or warning sound to alert the driver. The electronic side view mirror warning system can actively detect driving road conditions and alert the driver when there is a risk within the expected driving range, thereby enhancing driving safety.

According to the aforementioned objectives, the present disclosure provides an electronic side view mirror warning system. The electronic side view mirror warning system includes two cameras, a processor, and a display device. The cameras are respectively mounted on both sides of a front of a vehicle. Each of the cameras is configured to capture a side image of a front wheel of the vehicle. The processor is disposed in a cab of the vehicle and in signal connection with the cameras. The processor stores a texture and at least one first image feature of each of plural road conditions, and at least one second image feature of each of plural objects. The processor is configured to receive the side images, and perform image recognition processing on the side images by using the textures, the first image features, and the second image features to obtain a driving road condition information of the vehicle. The display device is disposed in the cab and is in signal connection with the processor. The display device is configured to receive and display side images and issue a warning signal. When the driving road condition information indicates that there is a risk within an expected driving range of the vehicle, the processor controls the display device to issue the warning signal.

According to one embodiment of the present disclosure, the cameras are respectively mounted on two side view mirrors on a left side and a right side of the vehicle.

According to one embodiment of the present disclosure, a viewing angle range of each of the cameras is 120 degrees, and a shooting direction of each of the cameras is tilted 20 degrees toward an outside of the front of the vehicle.

According to one embodiment of the present disclosure, the processor is in signal connection with a direction light control system of the vehicle to obtain turning information of the vehicle. The processor controls the display device to issue the warning signal further based on the turning information.

According to one embodiment of the present disclosure, the processor is in signal connection with a steering wheel control system of the vehicle to obtain turning information of the vehicle. The processor controls the display device to issue the warning signal further based on the turning information.

According to one embodiment of the present disclosure, the driving road condition information includes whether the expected driving range of the vehicle is a drivable road and whether there is at least one obstacle within the expected driving range.

According to one embodiment of the present disclosure, the display device is a rectangular device, the display device is horizontally disposed in the cab. The display device has a rectangular display area, and the side images are arranged along a length direction of the rectangular display area.

According to one embodiment of the present disclosure, the display device issuing the warning signal includes flashing the side images.

According to one embodiment of the present disclosure, the processor is disposed in the display device, and the display device has a touch screen.

According to one embodiment of the present disclosure, the display device includes a speaker, and the speaker is in signal connection with the processor. When the driving road condition information indicates that there is a risk within the expected driving range of the vehicle, the processor controls the speaker to go off a warning sound.

### BRIEF DESCRIPTION OF THE DRAWINGS

Aspects of the present disclosure are best understood from the following detailed description in conjunction with the accompanying figures. It is noted that in accordance with the standard practice in the industry, various features are not drawn to scale. In fact, dimensions of the various features can be arbitrarily increased or reduced for clarity of discussion.

FIG. 1 is a block diagram of an electronic side view mirror warning system in accordance with an embodiment of the present disclosure.

FIG. 2 is a schematic diagram showing a camera of an electronic side view mirror warning system mounted on a vehicle in accordance with an embodiment of the present disclosure.

FIG. 3 is a schematic diagram showing an electronic side view mirror warning system installed on a vehicle in accordance with an embodiment of the present disclosure.

FIG. 4 is a schematic diagram of a display device of an electronic side view mirror warning system in accordance with an embodiment of the present disclosure.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. All of the embodiments of the present disclosure disclose various different features, and these features may be implemented separately or in combination as desired.

In addition, the terms “first”, “second”, and the like, as used herein, are not intended to mean a sequence or order, and are merely used to distinguish elements or operations described in the same technical terms.

The spatial relationship between two elements described in the present disclosure applies not only to the orientation depicted in the drawings, but also to the orientations not represented by the drawings, such as the orientation of the inversion. Moreover, the terms “connected”, “electrically connected”, or the like between two components referred to in the present disclosure are not limited to the direct connection or electrical connection of the two components, and may also include indirect connection or electrical connection as required.

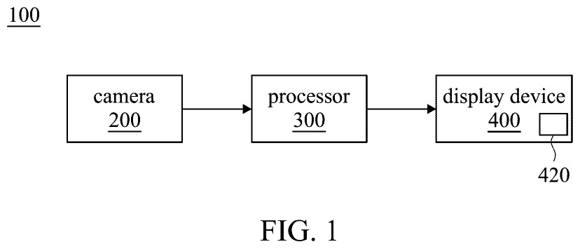

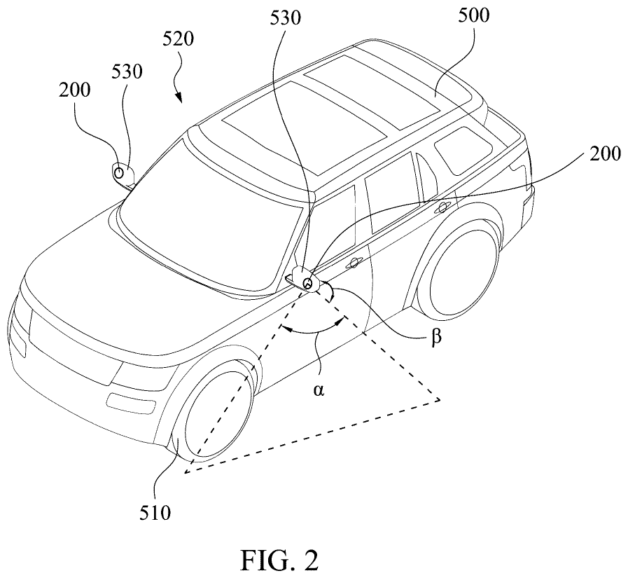

Referring to FIG. 1 to FIG. 3, FIG. 1 to FIG. 3 respectively illustrate is a block diagram of an electronic side view mirror warning system 100, a schematic diagram showing a camera 200 of the electronic side view mirror warning system 100 mounted on a vehicle 500, and a schematic diagram showing the electronic side view mirror warning system 100 installed on the vehicle 500 in accordance with an embodiment of the present disclosure. The electronic side view mirror warning system 100 is applied to a general vehicle 500, such as a car, a jeep, a pickup truck, or a van. The electronic side view mirror warning system 100 can provide the driver with driving road condition information and warnings in front of the vehicle 500 and beside front wheels 510, thereby enhancing driving safety.

The electronic side view mirror warning system 100 may mainly include two cameras 200, a processor 300, and a display device 400. The cameras 200 are respectively mounted on two sides of a front 520 of the vehicle 500. For example, the two cameras 200 may be respectively mounted on view mirrors 530 on a left side and a right side of the vehicle 500. Each of the cameras 200 is configured to capture a side image SI1 or a side image SI2 of the front wheel 510 on that side of the vehicle 500 where it is mounted. The side images SI1 and SI2 of the front wheels 510 both cover the front and the rear of the front wheels 510. In some examples, a viewing angle range a of each of the cameras 200 is substantially 120 degrees, and a tilt angle β of a shooting direction of each of the cameras 200 toward an outside of the front 520 is substantially 20 degrees. For example, the viewing angle range a of each of the camera 200 is from 60 degrees in front to 60 degrees behind where each of the cameras 200 is mounted. In addition, a lens of each of the cameras 200 is tilted 20 degrees toward the outside of the front 520 of the vehicle, such that the shooting direction of each of the cameras 200 has a titled angle β of 20 degrees.

The processor 300 is disposed in a cab 540 of the vehicle 500. The processor 300 may be in signal connection with the cameras 200 through a wired transmission method or a wireless transmission method. Thus, the processor 300 can receive the side images SI1 and SI2 of the front wheels 510 of the vehicle 500 captured by the cameras 200. In the present embodiment, the processor 300 stores a texture and at least one first image feature of each of plural road conditions, and at least one second image feature of each of plural objects. Specifically, the processor 300 stores a texture and at least one first image feature of each of drivable roads, such as a flat meadow, a concrete floor, an asphalt road, a brick road, etc. The processor 300 also stores a texture and at least one first image feature of each of undrivable road, such as water, a pothole, a curb, a traffic island, etc. In addition, the processor 300 stores one or more second image features of each of the objects, such as people, animals, cars, motorcycles, bicycles, triangle cones, fire hydrants, fences, etc.

The processor 300 can further use the stored textures, the first image features, and the second image features to perform image recognition processing on the side images SI1 and SI2 of the front wheels 510 to use, for example, artificial intelligence (AI) operations to compare and recognize the textures and image features of the side images SI1 and SI2 to obtain the driving road condition information of the vehicle 500. For example, when the processor 300 recognizes that the texture of the pothole and the image feature of the pothole appear in the side images SI1 and SI2 of the front wheel 510, the processor 300 can further obtain the driving road condition information based on the recognition result, that is, there is a pothole in the expected driving range of the vehicle 500, which is a type of undrivable road. For another example, when the processor 300 recognizes the side images SI1 and SI2 of the front wheel 510 with the texture and image features of a flat asphalt road as well as the image features of a child, the processor 300 can obtain the driving road condition information of an obstacle on the drivable roads within the expected driving range of the vehicle 500 based on the recognition results. Therefore, the processor 300 can recognize the side images SI1 and SI2 of the front wheels 510 and obtain the driving road condition information including whether the expected driving range of the vehicle 500 is a drivable road and whether there is at least one obstacle within the driving range.

In some examples, the processor 300 is in signal connection with a direction light control system of the vehicle 500 by using a wired transmission method or a wireless transmission method to obtain turning information of the vehicle 500. In other examples, the processor 300 is in signal connection with steering wheel control system of the vehicle 500 by using a wired transmission method or a wireless transmission method to obtain accurate turning information of the vehicle 500. The processor 300 can combine the driving road condition information and the turning information of the vehicle 500 to control the display device 400 to issue a warning signal.

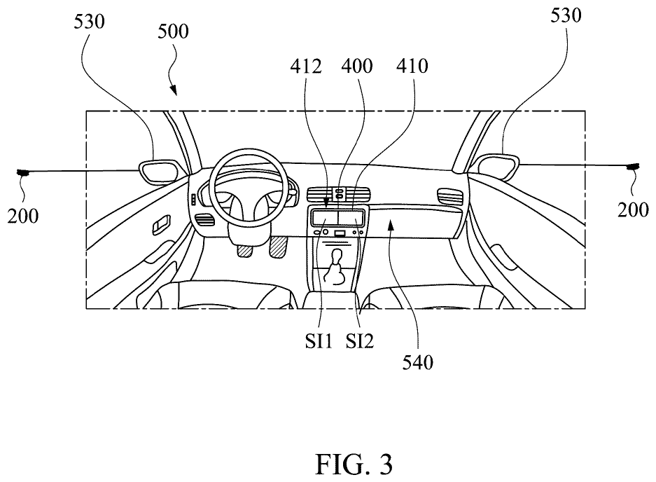

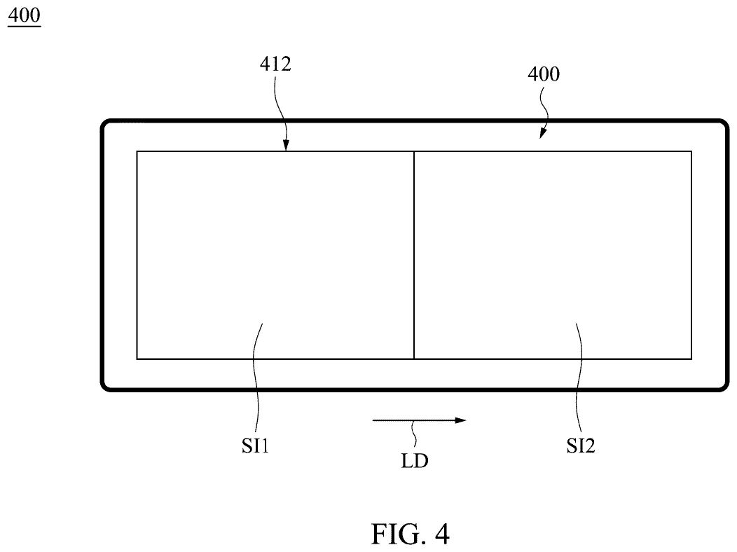

Referring to FIG. 3 and FIG. 4, FIG. 4 is a schematic diagram of a display device 400 of an electronic side view mirror warning system 100 in accordance with an embodiment of the present disclosure. As shown in FIG. 3, the display device 400 is disposed in the cab 540 of the vehicle 500, and may be in signal connection with the processor 300 via a wired transmission method or a wireless transmission method. In some examples, the processor 300 may be disposed in the display device 400 and be electrically connected to the display device 400 through physical wires. The display device 400 can receive the side images SI1 and SI2 of the front wheels 510 from the processor 300 and display the side images SI1 and SI2. The display device 400 includes a screen 410, and the screen has a display area 412 for displaying the side images SI1 and SI2.

In some examples, as shown in FIG. 3, the display device 400 is a rectangular device, and the display device 400 is horizontally disposed in the cab 540. That is, the screen 410 of the display device 400 has a rectangular display area 412, and a length direction LD of the rectangular display area 412 extends horizontally. The side images SI1 and SI2 are arranged along the length direction LD of the rectangular display area 412. That is, the side images SI1 and SI2 are arranged left and right, which makes the driver more intuitive in viewing.

The display device 400 can further issue a warning signal. Specifically, when the driving road condition information indicates that there are risks within the expected driving range of the vehicle 500, such as when it is an undrivable road or there are obstacles, the processor 300 controls the display device 400 to issue the warning signal. For example, the display device 400 may issue the warning signal by flashing the side image SI1 or SI2 containing the obstacle or the undrivable road. That is, when the processor 300 recognizes that there is an obstacle or an undrivable road in the side image SI1, the processor 300 controls the display device 400 to display the side image SI1 in a flashing manner.

The screen 410 of the display device 400 may be, for example, a touch screen. Thus, the screen 410 of the display device 400 can be used as a human-machine operation interface to facilitate the driver to set the shooting angle of the cameras 200, the image recognition of the processor 300, and the display settings and warning settings of the display device 400, etc.

In some examples, as shown in FIG. 1, the display device 400 may include a speaker 420. The speaker 420 may be in signal connection with the processor 300 via a wired transmission method or a wireless transmission method similarly. When the driving road condition information obtained by the processor 300 through recognizing the side images SI1 and SI2 is that there is a risk within the driving range of the vehicle 500, the processor 300 controls the speaker 420 to go off a warning sound to alert the driver to pay attention. For example, when the processor 300 recognizes the driving road condition information is that there is an obstacle on the left side of the front wheel 510 at the left of the vehicle 500, and obtains from the direction light control system or the steering wheel control system that the vehicle 500 intends to turn left, the processor can control the speaker 420 to go off a warning sound in addition to controlling the display device 400 to display the side image SI1 in a flashing manner to enhance the warning effect.

According to the embodiments described above, one advantage of the present disclosure is that the processor of the electronic side view mirror warning system can receive the side images of the front wheels on both sides of the vehicle captured by cameras, and can use a texture and image feature database built in the processor to perform image recognition processing on the side images, such that the driving road condition information such as whether the expected driving range of the vehicle is a drivable road and whether there are obstacles. According to the driving road condition information, the processor can control the display device to issue a warning screen and/or warning sound to alert the driver. The electronic side view mirror warning system can actively detect driving road conditions and alert the driver when there is a risk within the expected driving range, thereby enhancing driving safety.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. An electronic side view mirror warning system, comprising:
two cameras respectively mounted on both sides of a front of a vehicle, wherein each of the cameras is configured to capture a side image of a front wheel of the vehicle;
a processor disposed in a cab of the vehicle and in signal connection with the cameras, wherein the processor stores a texture and at least one first image feature of each of a plurality of road conditions, and at least one second image feature of each of a plurality of objects, and the processor is configured to receive the side images, and perform image recognition processing on the side images by using the textures, the first image features, and the second image features to obtain a driving road condition information of the vehicle; and
a display device disposed in the cab and in signal connection with the processor, wherein the display device is configured to receive and display side images and issue a warning signal, and when the driving road condition information indicates that there is a risk within an expected driving range of the vehicle, the processor controls the display device to issue the warning signal.

2. The electronic side view mirror warning system of claim 1, wherein the cameras are respectively mounted on two side view mirrors on a left side and a right side of the vehicle.

3. The electronic side view mirror warning system of claim 1, wherein a viewing angle range of each of the cameras is 120 degrees, and a shooting direction of each of the cameras is tilted 20 degrees toward an outside of the front of the vehicle.

4. The electronic side view mirror warning system of claim 1, wherein the processor is in signal connection with a direction light control system of the vehicle to obtain turning information of the vehicle, and the processor controls the display device to issue the warning signal further based on the turning information.

5. The electronic side view mirror warning system of claim 1, wherein the processor is in signal connection with a steering wheel control system of the vehicle to obtain turning information of the vehicle, and the processor controls the display device to issue the warning signal further based on the turning information.

6. The electronic side view mirror warning system of claim 1, wherein the driving road condition information comprises whether the expected driving range of the vehicle is a drivable road and whether there is at least one obstacle within the expected driving range.

7. The electronic side view mirror warning system of claim 1, wherein the display device is a rectangular device, the display device is horizontally disposed in the cab, the display device has a rectangular display area, and the side images are arranged along a length direction of the rectangular display area.

8. The electronic side view mirror warning system of claim 1, wherein the display device issuing the warning signal comprises flashing the side images.

9. The electronic side view mirror warning system of claim 1, wherein the processor is disposed in the display device, and the display device has a touch screen.

10. The electronic side view mirror warning system of claim 1, wherein the display device comprises a speaker, the speaker is in signal connection with the processor, and when the driving road condition information indicates that there is a risk within the expected driving range of the vehicle, the processor controls the speaker to go off a warning sound.
